(19) United States
(12) Patent Application Publication
(10) Pub. No.: US 2006/0283280 A1
(43) Pub. Date: Dec. 21, 2006

(54) Industrial truck with a multi-function lever

(75) Inventors: Marek Szymanski, Wentorf (DE); Roland Tiedemann, Berlin (DE)

Correspondence Address: THE WEBB LAW FIRM, P.C., 700 KOPPERS BUILDING, 436 SEVENTH AVENUE, PITTSBURGH, PA, 15219, US

(73) Assignee: STILL GmbH, Hamburg (DE)

(21) Appl. No.: 11/409,727

(22) Filed: Apr. 24, 2006

(30) Foreign Application Priority Data
Apr. 26, 2005 (DE) 10 2005 019 321.8

(51) Int. Cl. B62K 25/00

(52) U.S. Cl. 74/473.13

(57) ABSTRACT

An industrial truck has a multi-function lever for control of the movement of a load handling attachment (4) of the industrial truck. The multi-function lever has a handle element (12). The handle element (12) is essentially immobile and at least one sensor is associated with the handle element (12) for measurement of an actuation force that is exerted on the handle element (12) and/or of an actuation moment that is exerted on the handle element (12). The sensor is effectively connected with an electrical control device of the industrial truck. The control device is realized so that the speed of the movement of the load handling attachment (4) is set as a function of the magnitude of the actuation force and/or of the magnitude of the actuation moment.

### CROSS-REFERENCE TO RELATED APPLICATION

This application claims priority to German Application No. 10 2005 019 321.8, filed Apr. 26, 2005, herein incorporated by reference in its entirety.

### BACKGROUND OF THE INVENTION

1. Field of the Invention

This invention relates to an industrial truck with a multi-function lever to control the movement of a load handling attachment of an industrial truck, wherein the multi-function lever has a handle element.

2. Technical Considerations

Conventionally, either a plurality of individual levers or a single multi-function lever are provided for control by the operator of the numerous functions of an industrial truck. Multi-function levers of the known art generally have a handle that can be tilted around a transverse axis and around a longitudinal axis of the industrial truck. The handle has a plurality of switches that can be actuated by the operator's fingers. The functions that can be controlled with a multi-function lever are generally the vertical movement of a load handling attachment, the tilting of a load handling attachment, and the lateral displacement of a load handling attachment. Many multi-function levers can also be used to specify the direction of travel of the industrial truck.

In practical use, multi-function levers of the known art require continuously repeated movements of the operator's hand. Because of the mobility of the multi-function lever, the operator's hand is thereby occasionally in ergonomically disadvantageous positions. This disadvantage promotes the occurrence of health problems for the operator, including but not limited to Repetitive Stress Injury (RSI).

Therefore, it is an object of this invention to provide an industrial truck with a multi-function lever in which the danger of adverse effects on the health of the operator is significantly reduced.

### SUMMARY OF THE INVENTION

The invention teaches that the handle element of a multi-function lever is essentially immobile. At least one sensor is associated with the handle element for detection of an actuation force exerted on the handle element and/or of an actuation moment exerted on the handle element. The sensor is effectively connected with an electrical control device of the industrial truck.

In one embodiment, the multi-function lever is realized in the form of an isometric control element and, when it is actuated, does not execute any movement, except, for example, for elastic deformations. In the context of this invention, control elements that can be deflected from a neutral position by a maximum of 5 mm and, preferably, by a maximum of 3 mm are also considered “essentially” immobile control elements. Instead of a physical movement of the multi-function lever, the sensor measures the force that is exerted by the operator on the multi-function lever. The multi-function lever can be optimally positioned and oriented from an ergonomic point of view. Because the multi-function lever does not move from this optimized position, at no time is the operator's hand in an ergonomically disadvantageous position. The actuation force is measured by suitable force measurement sensors, which can be based on strain gauge technology, for example. For the measurement of torques and moments, special torque or moment measurement sensors can be provided. It is also possible to measure an actuation moment by means of two force measurement sensors that are located at some distance from each other. The output signals of the sensors can be evaluated in the electrical control device, which then actuates the load handling attachment of the industrial truck accordingly.

It is particularly advantageous if the control device is realized so that the speed of movement of the load holding device is set as a function of the magnitude of the actuation force or the magnitude of the actuation moment. The speed of movement of the load handling attachment can thereby be controlled continuously by the operator. The actuation force or the actuation moment exerted by the operator on the handle element is thereby measured continuously or in fine gradations by at least one related sensor.

It is advantageous to have at least one sensor located in the vicinity of a fastening point of the handle element to a base body of the multi-function lever. The sensor thereby measures the total force that is being exerted on the handle element in the direction in question. There can also be a plurality of sensors in the vicinity of the fastening point of the handle element to the base body. In which case, each sensor measures the force exerted in a defined direction.

Alternatively, it is possible to have at least one sensor located in the vicinity of the surface where the operator's hand touches the handle element. The force exerted on the handle element is, therefore, measured directly at the point where the operator introduces the force into the handle element.

In one advantageous configuration of the invention, the handle element has a sensor for measurement of a vertical actuation force and the electrical control device is realized so that a movement of the load handling attachment in the vertical direction is actuated as a function of the output signal of the sensor for the measurement of the vertical actuation force. The vertical movement of the load handling attachment, i.e., the raising and lowering of the load handling attachment, is controlled by the operator by exerting an upward or downward force on the handle element in the corresponding direction.

It is also advantageous if the handle element has a sensor for measurement of a horizontal actuation force in the transverse direction of the industrial truck and the electrical control device is realized so that a movement of the load handling attachment in the transverse direction of the industrial truck is actuated as a function of the output signal of the sensor for the measurement of an actuator force in the transverse direction of the industrial truck. A movement of the load handling attachment in the transverse direction of the industrial truck, i.e., to the left or to the right, can be effected by means of a side-thrust device, for example. For the actuation of this function, the operator exerts a force on the handle element in the corresponding direction.

Alternatively, it is possible to use the handle element to also control a steering device of the industrial truck. The handle element has a sensor for the measurement of an actuation force in the transverse direction of the industrial truck, and the electrical control device is realized so that a steering device of the industrial truck is actuated as a function of the output signal of the sensor for the measurement of an actuation force in the transverse direction of the industrial truck. The exertion of a force directed to the left or to the right on the handle element thereby effects a steering of the industrial truck to the left or to the right.

Reach trucks and industrial trucks with a retractable fork and/or a retractable mast have a device for the displacement of the load handling attachment in the longitudinal direction. On these types of industrial trucks, it is advantageous if the handle element has a sensor for the measurement of a horizontal actuation force in the longitudinal direction of the industrial truck and the electrical control device is realized so that a movement of the load handling attachment in the longitudinal direction of the industrial truck is actuated as a function of the output signal of the sensor for the measurement of the actuation force in the longitudinal direction of the load handling attachment. This function can also be actuated by exerting a force on the handle element in the desired direction of movement of the load handling attachment.

On industrial trucks that do not have a thrust device for the load in the longitudinal direction of the industrial truck, it is advantageous if the handle element can also be used to control a direction of travel and/or a speed of travel of the industrial truck. The handle element can have a sensor for the measurement of a horizontal actuation force in the longitudinal direction of the industrial truck and the electrical control device is realized so that the direction of travel and/or the speed of travel of the industrial truck can be controlled as a function of the output signal of the sensor for the measurement of the actuation force in the longitudinal direction of the industrial truck. In a first variant, the handle element is used to specify only the direction of travel, i.e., forward or reverse travel, and the speed of travel is controlled by means of a separate control element, e.g., by means of a foot pedal. In the second variant, the handle element is used to control both the direction of travel as well as the speed of travel, with the speed of travel being set as a function of the actuation force exerted on the handle element in the corresponding direction.

In one development of the invention, the handle element has a sensor for the measurement of an actuation torque around a transverse axis of the industrial truck and the electrical control device is realized so that a movement of the load handling attachment around a transverse axis of the industrial truck is actuated as a function of the output signal of the sensor that measures the actuation torque around a transverse axis of the industrial truck. A forward and backward tilting of the load handling attachment is, therefore, controlled by the exertion of a torque in the corresponding direction on the handle element.

It is also possible for the handle element to have a sensor for the measurement of an actuation torque around a longitudinal axis of the industrial truck and for the electrical control device to be realized so that a movement of the load handling attachment around a longitudinal axis of the industrial truck is actuated by the output signal of the sensor for the measurement of the actuation torque around the longitudinal axis of the industrial truck. A device for the rotation of the load handling attachment around the longitudinal axis of the industrial truck is frequently present when the load handling attachment is realized in the form of bale tongs or conventional tongs. This function is actuated by exerting a torque on the handle element around an axis in the direction of the intended movement.

### BRIEF DESCRIPTION OF THE DRAWINGS

Additional advantages and details of the invention are described in greater detail below with reference to the exemplary embodiment that is illustrated in the accompanying schematic figures, in which like reference numbers identify like parts throughout.

FIG. 1 shows an industrial truck in the form of a fork-lift truck; and

FIG. 2 shows a multi-function lever of the invention.

### DESCRIPTION OF THE PREFERRED EMBODIMENTS

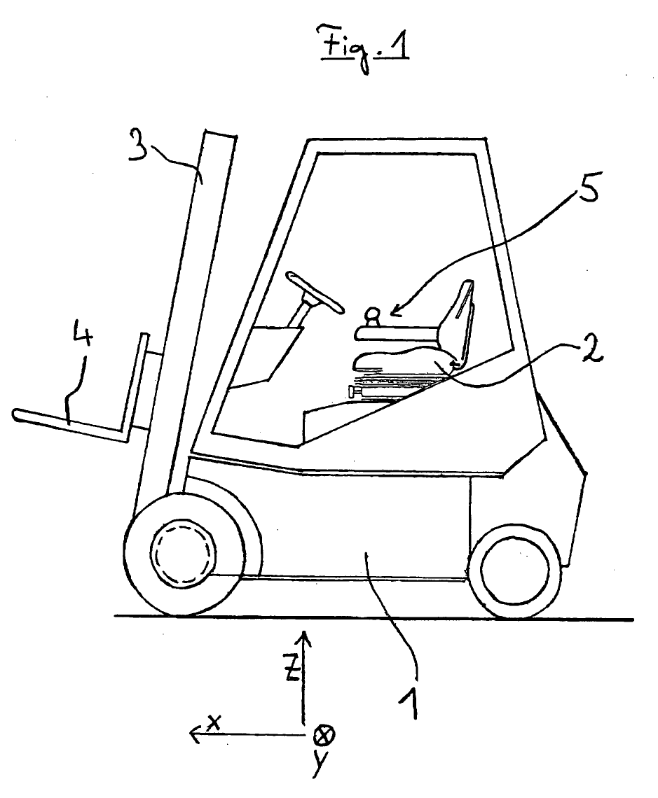

FIG. 1 is a schematic illustration of an industrial truck that is realized in the form of a fork-lift truck. The figure shows a vehicle frame 1, a driver's seat 2 which is oriented in the longitudinal direction of the vehicle, a lifting frame 3 that is located in front of the driver's seat 2, and a load handling attachment 4 that can be moved vertically along the lifting frame 3 and is realized in the form of a load fork. Associated with the driver's seat 2 is a control unit 5 with a multi-function lever for the control of various functions of the industrial truck, such as of the load handling attachment 4, a traction drive, and a steering device. The directions of movement of the load handling attachment 4 and the corresponding directions of actuation of the multi-function lever are described below on the basis of the right-angle coordinate system shown in the drawings. The coordinate axis x thereby corresponds to the longitudinal direction of the industrial truck, the coordinate axis y to the transverse direction of the industrial truck and the coordinate axis z to a vertical direction.

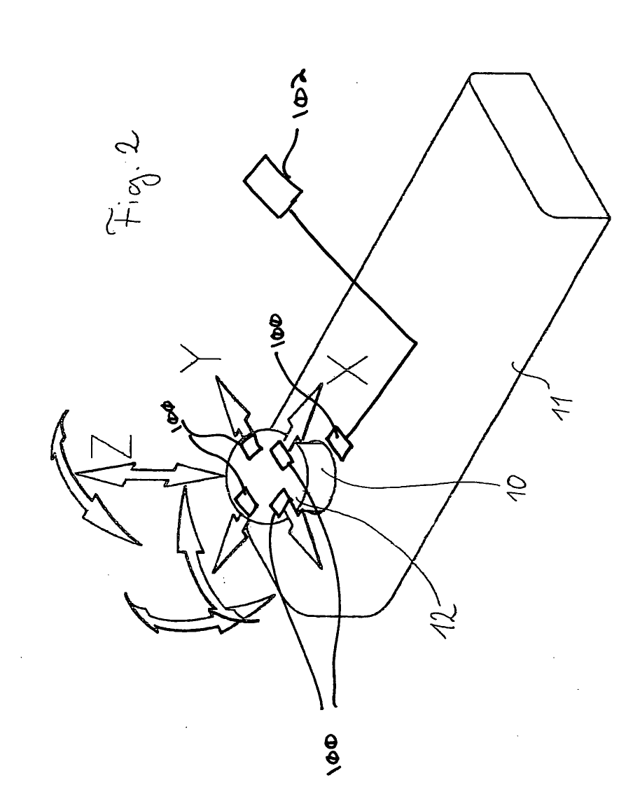

FIG. 2 shows a multi-function lever of the invention. A base body 10 of the multi-function lever is a component of an armrest 11, which is associated with the driver's seat 2. A handle element 12 of the multi-function lever is essentially stationary relative to the base body 10. The forces exerted on the handle element 12 by an operator, however, are measured by means of one or more sensors 100. It is thereby possible to measure the forces that are exerted in the direction of all three coordinate axes x, y, and z. Torques around all three coordinate axes x, y, and z can also be measured. The coordinate system of the multi-function lever thereby corresponds at least approximately to the coordinate system of the industrial truck that is illustrated in FIG. 1. Overall, therefore, up to six functions of the industrial truck can be controlled by exerting forces and moments on the handle element 12. Additional control elements can also be located on the multi-function lever or in the immediate vicinity of the multi-function lever, which can then be used by the operator to actuate additional functions with the same hand. The sensors 100 can be connected with an electrical control device 102 of the industrial truck.

The functions listed below of the industrial truck can thereby be associated with the various directions of the forces and moments exerted on the handle element 12:
Actuation force in the direction z: raising or lowering of the load handling attachment 4 in the direction z;
Actuation torque around the y-axis: tilting of the load handling attachment 4 or of the lifting frame 3 around the y-axis;
Actuation torque around the x-axis: rotation of load handling attachment 4, which can be realized in the form of bale tongs, for example, around the x-axis;
Movement of or actuation force on the handle element 12 in the direction y: displacement of the load handling attachment 4 in the direction y or steering of the industrial truck;
Rotation of or actuation torque on the handle element 12 around the z-axis: opening or closing of the load handling attachment 4, which can be realized in the form of bale tongs, for example; and
Movement of or actuation force on the handle element 12 in the direction x: definition of the direction of travel and/or the speed of travel of the industrial truck in the forward or reverse direction; or on reach trucks or trucks with retractable masts: movement of the load handling attachment 4 in the direction x.

In other realizations of the industrial truck, and on industrial trucks that are otherwise equipped, the movements of the handle element 12 can be associated with other or additional functions. The handle element 12 can also be shaped in any desired manner, for example from an ergonomic point of view.

It will be readily appreciated by those skilled in the art that modifications may be made to the invention without departing from the concepts disclosed in the foregoing description. Accordingly, the particular embodiments described in detail herein are illustrative only and are not limiting to the scope of the invention, which is to be given the full breadth of the appended claims and any and all equivalents thereof.

What is claimed is:

1. An industrial truck, comprising:
a multi-function lever for control of movement of a load handling attachment of an industrial truck, the multi-function lever comprising a handle element, wherein the handle element is essentially immobile and at least one sensor is associated with the handle element for measurement of an actuation force that is exerted on the handle element and/or of an actuation moment that is exerted on the handle element, and wherein the sensor is effectively connected with an electrical control device of the industrial truck.

2. The industrial truck as claimed in claim 1, wherein the control device is realized so that a speed of the movement of the load handling attachment is set as a function of the magnitude of the actuation force and/or the magnitude of the actuation moment.

3. The industrial truck as claimed in claim 1, wherein the at least one sensor is located in the vicinity of a fastening point of the handle element on a base body of the multi-function lever.

4. The industrial truck as claimed in claim 1, wherein the at least one sensor is located in an area of the handle element where an operator's hand touches the surface of the handle element.

5. The industrial truck as claimed in claim 1, wherein the handle element has a sensor for measurement of a vertical actuation force and the electrical control device is realized so that a movement of the load handling attachment in the vertical direction is actuated as a function of an output signal of the sensor for the measurement of the vertical actuation force.

6. The industrial truck as claimed in claim 1, wherein the handle element has a sensor for measurement of a horizontal actuation force in a transverse direction (y) of the industrial truck, and the electrical control device is realized so that a movement of the load handling attachment in the transverse direction (y) of the industrial truck is actuated as a function of an output signal of the sensor for the measurement of an actuation force in the transverse direction (y) of the industrial truck.

7. The industrial truck as claimed in claim 1, wherein a steering device of the industrial truck is also controlled by the handle element, wherein the handle element has a sensor for measurement of a horizontal actuation force in the transverse direction (y) of the industrial truck and the electrical control device is realized so that a steering device of the industrial truck is actuated as a function of the output signal of the sensor for measurement of an actuation force in the transverse direction (y) of the industrial truck.

8. The industrial truck as claimed in claim 1, wherein the handle element has a sensor for measurement of a horizontal actuation force in the longitudinal direction (x) of the industrial truck and the electrical control device is realized so that a movement of the load handling attachment in the longitudinal direction (x) of the industrial truck is actuated as a function of an output signal of the sensor for measurement of the actuation force.

9. The industrial truck as claimed in claim 1, wherein the handle element controls a direction of travel and/or a speed of travel of the industrial truck, wherein the handle element has a sensor for measurement of a horizontal actuation force in the longitudinal direction (x) of the industrial truck, and the electrical control device is realized so that the direction of travel and/or the speed of travel of the industrial truck is controlled as a function of an output signal of the sensor for measurement of the actuation force in the longitudinal direction (x) of the industrial truck.

10. The industrial truck as claimed in claim 1, wherein the handle element has a sensor for measurement of an actuation torque around the transverse axis (y) of the industrial truck and the electrical control device is realized so that a movement of the load handling attachment around a transverse axis (y) of the industrial truck is actuated as a function of an output signal of the sensor for measurement of the actuation torque around the transverse axis (y) of the industrial truck.

11. The industrial truck as claimed in claim 1, wherein the handle element has a sensor for measurement of an actuation torque around a longitudinal axis (x) of the industrial truck, and the electrical control device is realized so that a movement of the load handling attachment around a longitudinal axis (x) of the industrial truck is actuated as a function of an output signal of the sensor for measurement of the actuation torque around the longitudinal axis (x) of the industrial truck.
